(19) United States
(12) Patent Application Publication
(10) Pub. No.: US 2013/0070140 A1
(43) Pub. Date: Mar. 21, 2013

(54) IMAGE SENSORS WITH MULTIPLE LENSES OF VARYING POLARIZATIONS

(71) Applicants: Robert Gove, Los Gatos, CA (US); Curtis W. Stith, Santa Cruz, CA (US)

(72) Inventors: Robert Gove, Los Gatos, CA (US); Curtis W. Stith, Santa Cruz, CA (US)

(21) Appl. No.: 13/624,695

(22) Filed: Sep. 21, 2012

Related U.S. Application Data
(60) Provisional application No. 61/537,548, filed on Sep. 21, 2011.

(51) Int. Cl. H04N 5/335

(52) U.S. Cl. 348/302; 348/E05.091

(57) ABSTRACT

An electronic device may have a camera module. The camera module may include a camera sensor divided into two or more regions. The various regions of the camera sensor may include lenses that filter different polarizations of incident light. As one example, a first half of the camera sensor may include a lens that passes unpolarized light to the first half of the camera sensor, while a second half of the camera sensor may include a lens that passes light of a particular polarization to the second half of the camera sensor. If desired, the camera sensor may include microlenses over individual image sensing pixels. Some of the microlenses may select for particular polarizations of incident light. The electronic device may include a component that emits structured or polarized light and the camera sensor may have lenses that are mapped to the light emitted by the component.

This application claims the benefit of provisional patent application No. 61/537,548, filed Sep. 21, 2011, which is hereby incorporated by reference herein in its entirety.

### BACKGROUND

The present invention relates to imaging systems and, more particularly, to imaging systems with image sensors with multiple lenses of varying polarizations.

Electronic devices such as cellular telephones, camera, and computers often use digital camera modules to capture images. Typically, digital camera modules capture light that has passed through a lens. The lens is typically unpolarized (e.g., allows light of all polarizations to reach the camera modules). Occasionally, the lens is polarized (e.g., allows light of only a single polarization to reach the camera modules). Camera modules with these types of conventional lenses are unsatisfactory when imaging scenes illuminated by polarized light, by structured light, or by a combination of polarized and structured light.

### BRIEF DESCRIPTION OF THE DRAWINGS

FIG. 1 is a diagram of an illustrative electronic device that may include a camera sensor that captures images using multiple lenses of varying polarizations in accordance with an embodiment of the present invention.

FIG. 2 is a diagram of an illustrative array of light-sensitive imaging pixels and control circuitry coupled to the array of pixels that may form a camera sensor such as the camera sensor of FIG. 1 in accordance with an embodiment of the present invention.

FIG. 3A is a diagram of an illustrative image sensor formed from an array of light-sensitive imaging pixels showing how the array may be divided into two or more sections sensitive to different polarizations of light in accordance with an embodiment of the present invention.

FIG. 3B is a diagram of illustrative lenses that may be of different polarizations and that may be formed over the image sensor of FIG. 3A in accordance with an embodiment of the present invention.

FIG. 4 is a diagram of illustrative microlenses and imaging pixels that may be sensitive to green light, red light, blue light, and light of a particular type of polarization that may vary based on the location of the imaging pixels within a larger array in accordance with an embodiment of the present invention.

FIG. 5 is a diagram of an illustrative array of microlenses and imaging pixels such as the microlenses and imaging pixels of FIG. 4 in accordance with an embodiment of the present invention.

FIG. 6 is a perspective view of an illustrative electronic device that may include a camera sensor that captures images using multiple lenses of varying polarizations and that may include a device that provides structured and/or polarized light in accordance with an embodiment of the present invention.

FIG. 7 is a flowchart of illustrative steps involved in using an image sensor with multiple lenses of varying polarizations in capturing images in accordance with an embodiment of the present invention.

FIG. 8 is a block diagram of an imager employing one or more of the embodiments of FIG. 3A, 3B, 4, or 5 in accordance with an embodiment of the present invention.

FIG. 9 is a block diagram of a processor system employing the imager of FIG. 8 in accordance with an embodiment of the present invention.

### DETAILED DESCRIPTION

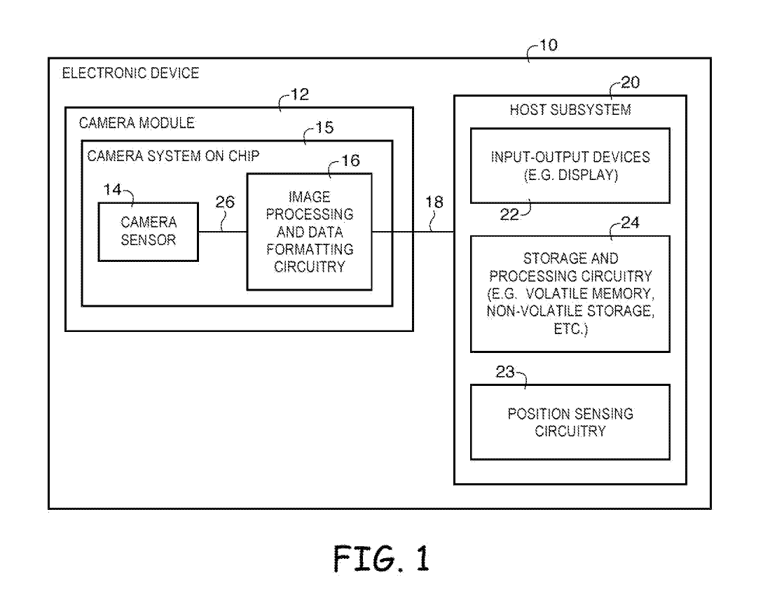

Digital camera modules are widely used in electronic devices. An electronic device with a digital camera module is shown in FIG. 1. Electronic device 10 may be a digital camera, a laptop computer, a display, a computer, a cellular telephone, or other electronic device. Imaging system 12 (e.g., camera module 12) may include an image sensor 14 and a lens. During operation, the lens focuses light onto image sensor 14. The pixels in image sensor 14 include photosensitive elements that convert the light into digital data. Image sensors may have any number of pixels (e.g., hundreds or thousands or more). A typical image sensor may, for example, have millions of pixels (e.g., megapixels). In high-end equipment, sensors with 10 megapixels or more are not uncommon.

Still and video image data from camera sensor 14 may be provided to image processing and data formatting circuitry 16 via path 26. Image processing and data formatting circuitry 16 may be used to perform image processing functions such as adjusting white balance and exposure and implementing video image stabilization, image cropping, image scaling, etc. Image processing and data formatting circuitry 16 may also be used to compress raw camera FIG. 9 image files if desired (e.g., to Joint Photographic Experts Group or JPEG format).

If desired, camera sensor 14 may be sensitive to light of varying polarizations. As one example, a first portion of camera sensor 14 may be sensitive to unpolarized light (e.g., light of any polarization) and a second portion of camera sensor 14 may be sensitive to polarized light (e.g., light of a particular polarization such as a particular orientation for linearly polarized light or a particular handedness for circularly polarized light). As another example, a first portion of camera sensor 14 may be sensitive to a first type of polarized light and a second portion of camera sensor 14 may be sensitive to a second type of polarized light. If desired, the first type of polarized light may be linearly polarized light or may be circularly polarized light. Similarly, the second type of polarized light may be linearly polarized light or may be circularly polarized light. Differences in the type of polarized light received by the first and second portions of camera sensor 14 may include differences in the kind of polarization (e.g., linear versus circular polarizations), in the handedness (if both types are circular polarization), or in the orientation (if both types are linear polarization). In general, camera sensor 14 may be divided into any desired number of regions, with each region being sensitive to light of a different polarization (or to unpolarized light). If desired, the number of regions that camera sensor 14 is divided into may equal the number of pixels, or some fraction thereof, in camera sensor 14.

In a typical arrangement, which is sometimes referred to as a system on chip or SOC arrangement, camera sensor 14 and image processing and data formatting circuitry 16 are implemented on a common integrated circuit 15. The use of a single integrated circuit to implement camera sensor 14 and image processing and data formatting circuitry 16 can help to minimize costs. If desired, however, multiple integrated circuits may be used to implement circuitry 15.

Circuitry 15 conveys data to host subsystem 20 over path 18. Circuitry 15 may provide acquired image data such as captured video and still digital images to host subsystem 20.

Electronic device 10 typically provides a user with numerous high level functions. In a computer or advanced cellular telephone, for example, a user may be provided with the ability to run user applications. To implement these functions, electronic device 10 may have input-output devices 22 such as projectors, keypads, input-output ports, and displays and storage and processing circuitry 24. Storage and processing circuitry 24 may include volatile and nonvolatile memory (e.g., random-access memory, flash memory, hard drives, solid state drives, etc.). Storage and processing circuitry 24 may also include processors such as microprocessors, microcontrollers, digital signal processors, application specific integrated circuits, etc.

Device 10 may include position sensing circuitry 23. Position sensing circuitry 23 may include, as examples, global positioning system (GPS) circuitry and radio-frequency-based positioning circuitry (e.g., cellular-telephone positioning circuitry).

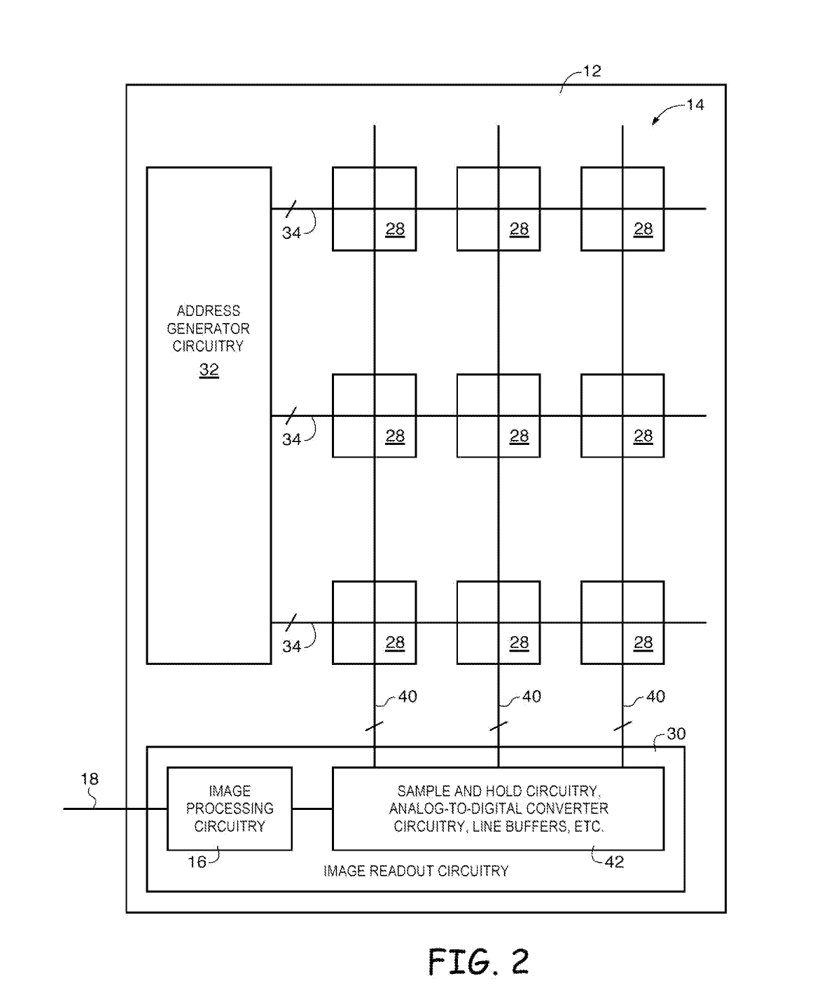

An example of an arrangement for sensor array 14 is shown in FIG. 2. As shown in FIG. 2, device 10 may include an array 14 of pixels 28 coupled to image readout circuitry 30 and address generator circuitry 32. As an example, each of the pixels in a row of array 14 may be coupled to address generator circuitry 32 by one or more conductive lines 34. Array 14 may have any number of rows and columns. In general, the size of array 14 and the number of rows and columns in array 14 will depend on the particular implementation. While rows and columns are generally described herein as being horizontal and vertical rows and columns may refer to any grid-like structure (e.g., features described herein as rows may be arranged vertically and features described herein as columns may be arranged horizontally).

Address generator circuitry 32 may generate signals on paths 34 as desired. For example, address generator circuitry 32 may generate reset signals on reset lines in paths 34, transfer signals on transfer lines in paths 34, and row select (e.g., row readout) signals on row select lines in paths 34 to control the operation of array 14. If desired, address generator circuitry 32 and array 14 may be integrated together in a single integrated circuit (as an example).

Signals 34, generated by address generator circuitry 32 as an example, may include signals that dynamically adjust the resolution of array 14. For example, signals 34 may include binning signals that cause pixels 28 in a first region of array 14 to be binned together (e.g., with a 2-pixel binning scheme, with a 3-pixel binning scheme, or with a pixel binning scheme of 4 or more pixels) and that cause pixels 28 in a second region of array 14 to either not be binned together or to be binned together to a lesser extent than the first region. In addition, signals 34 may cause pixels 28 in any number of additional (e.g., third, fourth, fifth, etc.) regions of array 14 to be binned together to any number of different, or identical, degrees (e.g., 2-pixel binning schemes, 3-or-more-pixel binning schemes, etc.).

Image readout circuitry 30 may include circuitry 42 and image processing and data formatting circuitry 16. Circuitry 42 may include sample and hold circuitry, analog-to-digital converter circuitry, and line buffer circuitry (as examples). As one example, circuitry 42 may be used to measure signals in pixels 28 and may be used to buffer the signals while analog-to-digital converters in circuitry 42 convert the signals to digital signals. In a typical arrangement, circuitry 42 reads signals from rows of pixels 28 one row at a time over lines 40. With another suitable arrangement, circuitry 42 reads signals from groups of pixels 28 (e.g., groups formed from pixels located in multiple rows and columns of array 14) one group at a time over lines 40. The digital signals read out by circuitry 42 may be representative of charges accumulated by pixels 28 in response to incident light. The digital signals produced by the analog-to-digital converters of circuitry 42 may be conveyed to image processing and data formatting circuitry 16 and then to host subsystem 20 (FIG. 1) over path 18.

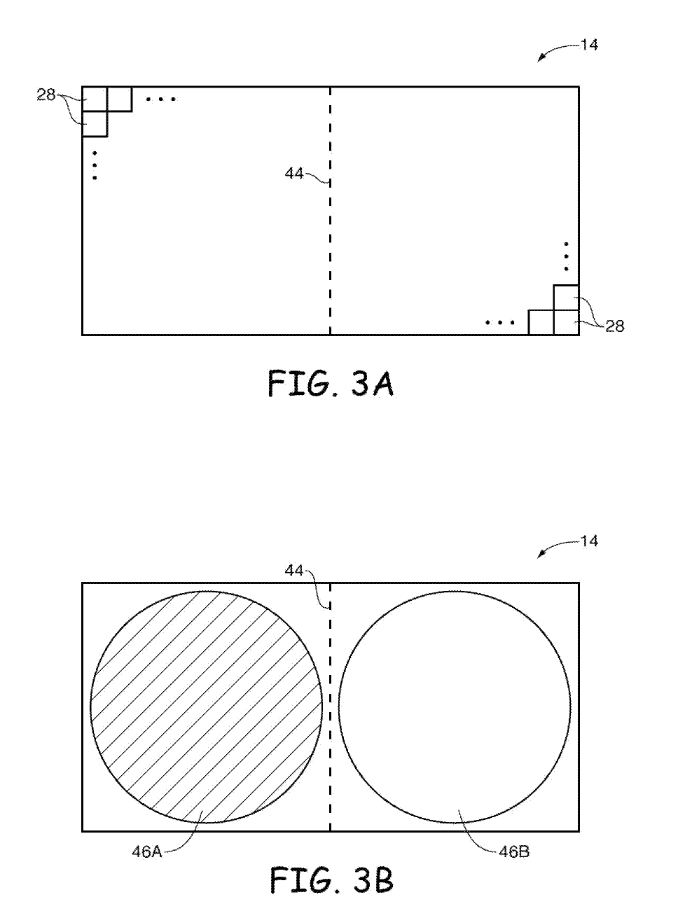

As shown in FIGS. 3A and 3B, image sensor 14 may be divided into two (or more) regions. As one example, image sensor 14 may be divided approximately in half (e.g., as shown by dashed line 44) into two region. As shown in FIG. 3B, lens 46A may be located over a first half of image sensor 14, while lens 46B may be located over a second half of image sensor 14. Lens 46A may pass (e.g., may be transparent to) light of all polarizations (e.g., may pass unpolarized light such that the underlying portions of image sensor 14 are sensitive to unpolarized light), while lens 47B may block (e.g., may be opaque to) light not in a particular polarization, such as a particular direction of linearly polarized light or a particular handedness of circularly polarized light, so that the underlying portions of image sensor 14 are sensitive to that particular polarization. While FIGS. 3A and 3B illustrate an arrangement in which image sensor is divided into only region, image sensor 14 may in general be divided into any desired number of regions.

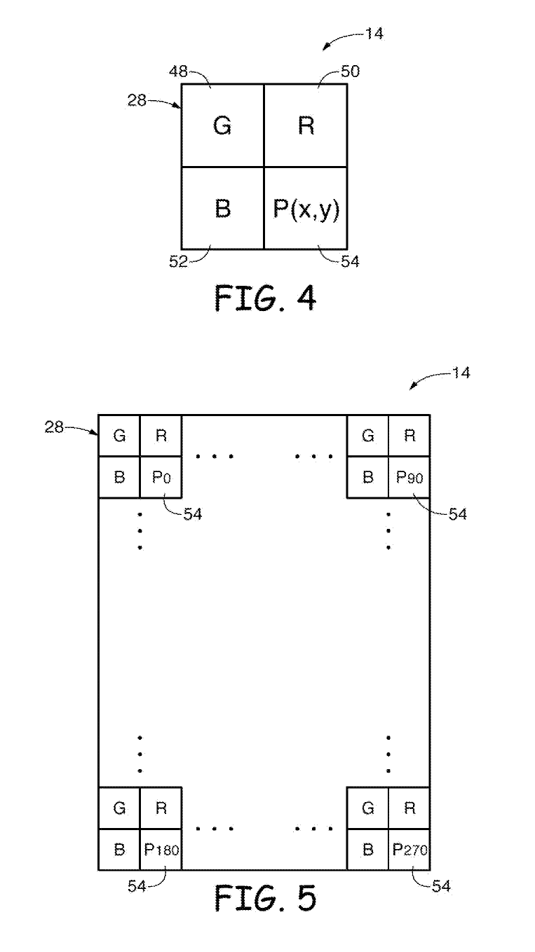

With some suitable arrangements, image sensor 14 may include microlenses that cover a single light sensitive pixel 28. If desired, each microlens may cover a group of two, three, four, or more pixels. As shown in the example of FIG. 4, image sensor array 14 may include a block of four pixels that includes green pixel 48, red pixel 50, blue pixel 52, and pixel 54. Pixels 48, 50, and 52 may respectively include a green, red, and blue filter (e.g., a microlens that passes green, red, or blue light).

Pixel 54 may include a filter that passes either unpolarized light or that passes a particular polarization of light. In some arrangements, the filter in pixel 54 may vary depending on the location of pixel 54 within the larger image sensor array 14. As shown by the P(x,y) label for pixel 54 in FIG. 4, the polarization (i.e., “P”), or polarizations, selected (e.g., passed) by the microlens for each pixel 54 may be a function of where that pixels 54 is located within array 14 (e.g., which row “x” and which column “y” of array 14 that particular pixel 54 is located in).

An example of an arrangement in which the microlens for each pixel 54 varies across image sensor array 14 is shown in FIG. 5. In the example of FIG. 5, the microlens for the pixel 54 in the upper-left corner of image sensor 14 may pass light having a linear polarization that is 0 degrees from vertical. The microlens for the pixel 54 in the upper-right corner may pass light having a linear polarization that is 90 degrees from vertical. The directions of polarization of light passed by the microlenses between the upper-left and upper-right corners may vary linearly from 0 degrees from vertical at the upper-left corner to 90 degrees from vertical at the upper-right corner. In a similar manner, the microlens for the pixel 54 in the lower-left corner of image sensor 14 may pass light having a linear polarization that is 180 degrees from vertical and the microlens for the pixel 54 in the lower-right corner of image sensor 14 may pass light having a linear polarization that is 270 degrees from vertical. The directions of polarization of light passed by the microlenses between the upper-left and lower-left corners may vary linearly from 0 degrees from vertical at the upper-left corner to 180 degrees from vertical at the lower-left corner. In each row, the directions of polarization of light passed by the microlenses between the left and right sides of that row may vary linearly from the direction passed by the left-most microlens to the direction passed by the right-most microlens. With arrangements of the type described in connection with FIGS. 4 and 5, image sensor 14 may be able to determine the abundance and direction or handedness of polarized light received by image sensor 14.

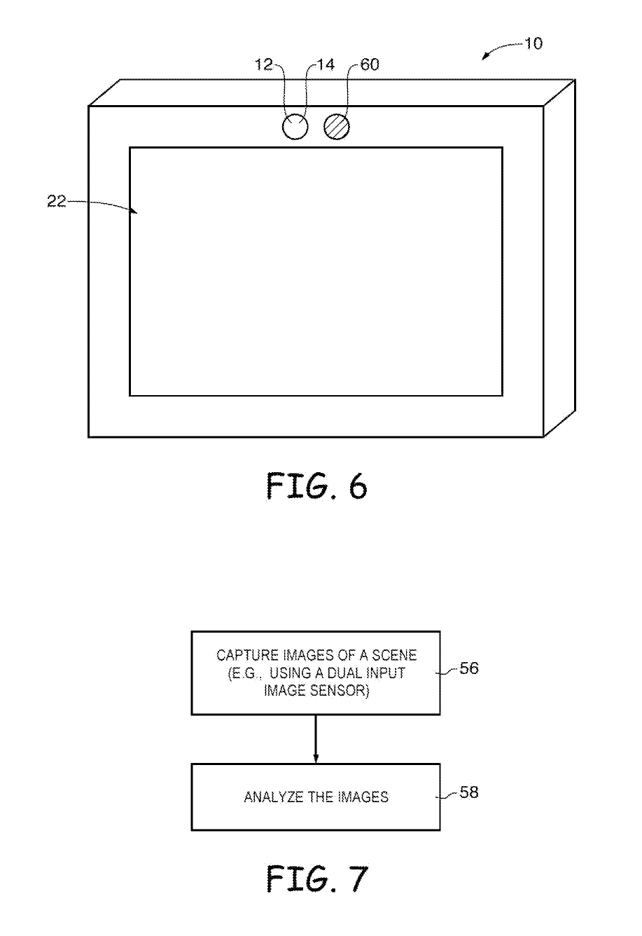

As shown in FIG. 6, if desired, electronic device 10 may include, in addition to camera module 12 and image sensor 14, a component that emits structured and/or polarized light. Image sensor 14 may, if desired, be mapped (e.g., calibrate) to capture the structured and/or polarized light emitted by the component. As examples, the component may be a display 22 that emits polarized light and an active illumination device 60 (e.g., a light source 60 such as a light emitting diode, a halogen lamp, an organic light emitting element or diode, a fluorescent lamp, etc.) that emits (e.g., projects) structured light and/or polarized light. If desired, the polarized and/or structured light emitted by light source 60 and display 22 may be in the near-infrared spectrum. Display 22 may also emit light in visible wavelengths as part of displaying images for users of device 10.

In some arrangements, image sensor 14 may include at least one polarized lens such as lens 46B that passes (to the underlying sensor 14) the structured and/or polarized light originally emitted by display 22 or light source 60. Image sensor 14 may then be able to capture light emitted by display 22 or light source 60 that has scattered off of nearby objects (e.g., that has illuminated those nearby objects). In arrangements in which the light emitted by display 22 or light source 60 include near-infrared wavelengths, image sensor 14 may be able to capture images of objects regardless of the visible-wavelength ambient lighting conditions (e.g., regardless of the whether the ambient environment is visibly bright or not and regardless of the visible-spectrum brightness of display 22).

A flowchart of illustrative steps involved in using image sensor 14 is shown in FIG. 7.

In step 56, image sensor 14 may capture one or more images of a scene. Image sensor 14 may be divided into at least two regions, a first of which may be sensitive to a first type of light (e.g., unpolarized light or light of a first particular polarization) and a second of which may be sensitive to a second type of light (e.g., unpolarized light or light of a second particular polarization).

In step 58, image processor circuitry such as image processing circuitry 15 in camera module 12 and/or processing circuitry 24 in host subsystem 20 may analyze the image or images captured in step 56. As an example, device 10 may identify sources of polarized light in the image(s) and may identify the polarization of light emitted or reflected by those sources. In step 58, device 10 may create one or more images from incident light collected by image sensor 14.

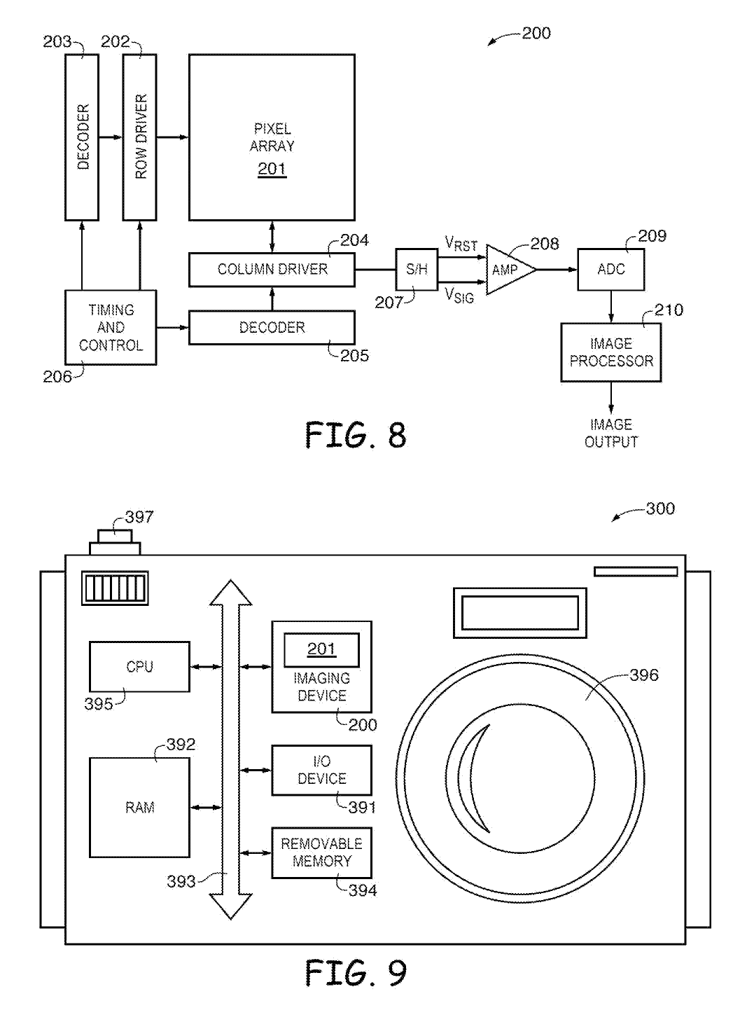

FIG. 8 illustrates a simplified block diagram of imager 200 (e.g., a CMOS imager having multiple lenses of varying polarizations as described herein). Pixel array 201 includes a plurality of pixels containing respective photosensors arranged in a predetermined number of columns and rows. The row lines are selectively activated by row driver 202 in response to row address decoder 203 and the column select lines are selectively activated by column driver 204 in response to column address decoder 205. Thus, a row and column address is provided for each pixel.

CMOS imager 200 is operated by a timing and control circuit 206, which controls decoders 203, 205 for selecting the appropriate row and column lines for pixel readout, and row and column driver circuitry 202, 204, which apply driving voltages to the drive transistors of the selected row and column lines. The pixel signals, which typically include a pixel reset signal Vrst and a pixel image signal Vsig for each pixel are sampled by sample and hold circuitry 207 associated with the column driver 204. A differential signal Vrst-Vsig is produced for each pixel, which is amplified by amplifier 208 and digitized by analog-to-digital converter 209. The analog to digital converter 209 converts the analog pixel signals to digital signals, which are fed to image processor 210 which forms a digital image.

FIG. 9 shows in simplified form a typical processor system 300, such as a digital camera, which includes an imaging device such as imaging device 200 (e.g., an imaging device 200 such as imaging device 14 of FIGS. 3A, 3B, 4, and 5 employing multiple lenses of varying polarizations). Processor system 300 is exemplary of a system having digital circuits that could include imaging device 200. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating imaging systems that may include multiple lenses of varying polarizations.

A camera sensor may be divided into two or more regions. Each region of the camera sensor may include a lens that passes light of a particular type (e.g., unpolarized light, light of a particular linear polarization, or light of a particular circular polarization). At least some light sensitive pixels within each region may receive white light (e.g., light of all visible wavelengths) or near-infrared light of the polarization passed by the lens of the region.

The camera sensor may be formed from an array of light-sensitive pixels. In some arrangements, the camera sensor may include a microlens over each pixel. Some of the microlenses may pass red, green, or blue light to the underlying pixels. Still other microlens may pass light such as unpolarized white light, unpolarized infrared light, white light of a particular polarization, and near-infrared light of a particular polarization to the underlying pixels. If desired, the type of polarization passed by these microlenses may vary within the array that forms the camera sensor (e.g., may vary depending on the location within the array).

The electronic device may include a component that emits structured or polarized light. In such arrangements, the camera sensor may have lenses that are mapped to the light emitted by the component. In particular, the component may emit light in a particular polarization and the lenses may pass light having the same polarization. As examples, the component may be a display device and may be an illumination device (e.g., a light that emits polarized, structured, visible, and/or near-infrared light).

The foregoing is merely illustrative of the principles of this invention and various modifications can be made by those skilled in the art without departing from the scope and spirit of the invention. The foregoing embodiments may be implemented individually or in any combination.

What is claimed is:

1. An imager comprising:
an array of image sensing pixels divided into at least first and second regions;
a first lens above the first region of the array, wherein the first lens is transparent to incident light having a first polarization; and
a second lens above the second region of the array, wherein the second lens is opaque to incident light having the first polarization.

2. The imager defined in claim 1 wherein the first lens is transparent to incident light regardless of the polarization of the incident light.

3. The imager defined in claim 1 wherein the first lens is opaque to incident light having any polarization other than the first polarization.

4. The imager defined in claim 1 wherein the second lens is transparent to incident light having a second polarization that is different from the first polarization.

5. The imager defined in claim 4 wherein the first and second polarizations are each selected from the group consisting of: a first linear polarization oriented at a first angle with respect to the array, a first linear polarization oriented at a second angle with respect to the array, a left-handed circular polarization, and a right-handed circular polarization.

6. The imager defined in claim 1 further comprising:
an array of microlenses, each of which is above a respective one of the image sensing pixels in the array.

7. The imager defined in claim 1 wherein the first and second lenses respectively comprise first and second microlenses in the array of microlenses.

8. The imager defined in claim 1 wherein the first polarization is selected from the group consisting of: a linear polarization oriented at a given angle with respect to the array, a left-handed circular polarization, and a right-handed circular polarization.

9. A system, comprising:
a central processing unit;
memory;
input-output circuitry;
a light emitting component operable to emit polarized light having the first polarization; and
an imaging device, wherein the imaging device comprises:
an array of image sensing pixels divided into at least first and second regions;
a first lens above the first region of the array, wherein the first lens is transparent to incident light having the first polarization and is opaque to incident light having any polarization other than the first polarization; and
a second lens above the second region of the array, wherein the second lens is transparent to incident light having at least one polarization other than the first polarization.

10. The system defined in claim 9 further comprising:
a display device, wherein the light emitting component is a part of the display device.

11. The system defined in claim 9 wherein the light emitting component emits near-infrared wavelengths of polarized light having the first polarization and wherein the first lens is transparent to incident light in the near-infrared wavelengths.

12. The system defined in claim 11 wherein the first lens is opaque to incident light that is not within the near-infrared wavelengths.

13. The system defined in claim 12 wherein the second lens is opaque to incident light that is within the near-infrared wavelengths and is transparent to incident light within the visible light spectrum.

14. The system defined in claim 9 wherein the second lens is transparent to incident light regardless of the polarization of the incident light.

15. The system defined in claim 9 wherein the second lens is transparent to incident light having a second polarization and is opaque to incident light having any polarization other than the second polarization.

16. The system defined in claim 9 wherein the first polarization is selected from the group consisting of: a linear polarization oriented at a given angle with respect to the array, a left-handed circular polarization, and a right-handed circular polarization.

17. A method of using an array of image sensing pixels divided into at least first and second regions, the method comprising:
using the first region of image sensing pixels, collecting incident light that has been filtered through a first lens that is transparent to incident light having a first polarization;
using the second region of image sensing pixels, collecting incident light that has been filtered through a second lens that is opaque to incident light having the first polarization; and
converting the incident light collected using the first and second regions of image sensing pixels into at least one digital image.

18. The method defined in claim 17 wherein the first lens is transparent to incident light regardless of the polarization of the incident light.

19. The method defined in claim 17 wherein the first lens is opaque to incident light having any polarization other than the first polarization.

20. The method defined in claim 17 wherein the second lens is transparent to incident light having a second polarization that is different from the first polarization.
